(19) United States
(12) Patent Application Publication
(10) Pub. No.: US 2024/0218678 A1
(43) Pub. Date: Jul. 4, 2024

(54) Connector Modules for Loose Fill Insulation Hose and Method of Installing Loose Fill Insulation

(71) Applicant: CertainTeed LLC, Malvern, PA (US)

(72) Inventors: Pierre Lombard, Malvern, PA (US); Bruce A. Hartzell, Mickleton, NJ (US)

(21) Appl. No.: 18/401,792

(22) Filed: Jan. 2, 2024

Related U.S. Application Data
(60) Provisional application No. 63/478,019, filed on Dec. 30, 2022.

(51) Int. Cl. E04F 21/08

(52) U.S. Cl. CPC E04F 21/085; F16L 33/02

(57) ABSTRACT

The present disclosure relates generally to loose fill insulation installation systems, for example, suitable for installing loose fill insulation to an installation site. The present disclosure relates more particularly to a kit for forming one or more connection modules for use with a loose fill insulation hose. The kit includes a plurality of module sections configured to be attached in a variety of configurations that provide different performance characteristics. Each of the module sections includes a tubular body extending from an upstream end to a downstream end and an interior surface that surrounds a flow path for conveying loose fill insulation. The kit includes at least a first fiber sizing module section, a first fiber conditioning module section, and an installation module section.

### CROSS-REFERENCE TO RELATED APPLICATIONS

This application claims the benefit of priority of U.S. Provisional Patent Application No. 63/478,019, filed Dec. 30, 2022, which is hereby incorporated herein by reference in its entirety.

### BACKGROUND OF THE DISCLOSURE

### 1. Field of the Disclosure

The present disclosure relates generally to loose fill insulation installation systems, for example, suitable for installing loose fill insulation to an installation site. The present disclosure relates more particularly to a kit for assembling a connection module for use with a loose fill insulation hose.

### 2. Technical Background

Loose fill insulation is packaged in bags in which the material becomes compacted prior to storage and shipment. When removed from the bags, the insulation separates into clumps. In order to effectively install the insulation material, it is initially conditioned to increase its volume and to reduce its density. Traditionally, pneumatic devices are used to both install the insulation and perform the conditioning. The conditioning process breaks up clumps and alters the arrangement of the fibers so as to “open up’ the insulation, conditioning the fiber to a more flake-like form. The conditioned insulation is then applied pneumatically to an area by blowing it through a hose connected to the pneumatic device. The insulation may be moistened and/or treated in the pneumatic device before installation.

While existing systems for installing loose fill insulation are effective, the present inventors have identified certain aspects of these systems that can be improved.

### SUMMARY OF THE DISCLOSURE

In one aspect, the present disclosure provides a kit for forming one or more connection modules for use with a loose fill insulation hose, the kit comprising:
a plurality of module sections configured to be attached in a variety of configurations that provide different performance characteristics, each of the module sections including a tubular body extending from an upstream end to a downstream end and including an interior surface that surrounds a flow path for conveying loose fill insulation, the plurality of module sections including:
   a first fiber sizing module section including an upstream connector disposed at the upstream end, a downstream connector disposed at the downstream end, and a plurality of cutting projections extending into the path that are configured to cut fibers of the loose fill insulation,
   a first fiber conditioning module section configured to open the loose fill insulation and including an upstream connector disposed at the upstream end and a downstream connector disposed at the downstream end, and
   an installation module section including an upstream connector disposed at the upstream end and a reducing portion that narrows the size of the tubular body, and a nozzle opening at the downstream end,
wherein each of the upstream connectors is adapted to couple to any of the downstream connectors.

In another aspect, the disclosure provides a method of delivering loose fill insulation, the method comprising:
assembling a first group of module sections of the kit of the disclosure to form a first connection module;
assembling a loose fill insulation hose having a first configuration and including a hose section and the first connection module;
connecting the loose fill insulation hose having the first configuration to a blowing machine;
loading a first quantity of loose fill insulation into the blowing machine; and
conveying the first quantity of loose fill insulation from the blowing machine, through the loose fill insulation hose having the first configuration, to a first installation site in a building structure.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1A is a schematic side view of a loose fill insulation system according to an embodiment of the disclosure.

FIG. 1B is a schematic front view of a portion of the loose fill insulation system of FIG. 1A.

FIG. 2A is a schematic perspective view of a module section according to an embodiment of the disclosure.

FIG. 2B is a schematic perspective cut away view of the module section of FIG. 2A.

FIG. 3A is a schematic perspective view of a module section according to an embodiment of the disclosure.

FIG. 3B is a schematic perspective cut away view of the module section of FIG. 3A.

FIG. 3C is a schematic cross-sectional side view of the module section of FIG. 3A.

FIG. 4A is a schematic perspective view of a module section according to an embodiment of the disclosure.

FIG. 4B is a schematic perspective cut away view of the module section of FIG. 4A.

FIG. 5A is a schematic perspective view of a module section according to an embodiment of the disclosure.

FIG. 5B is a schematic perspective cut away view of the module section of FIG. 5A.

FIG. 6A is a schematic perspective view of a module section according to an embodiment of the disclosure.

FIG. 6B is a schematic perspective cut away view of the module section of FIG. 6A.

### DETAILED DESCRIPTION

The present inventors have acknowledged that connection modules used in loose fill insulation hoses can significantly modify the installed loose fill insulation. Moreover, the inventors have identified that connection modules formed from various functional sections can be assembled to provide a range of desired performance characteristics of installed insulation for different applications.

Accordingly, one aspect of the disclosure is a kit for forming one or more connection modules for use with a loose fill insulation hose. The kit includes a plurality of module sections configured to be attached in a variety of configurations for forming connection modules that provide different performance characteristics. Each of the module sections includes a tubular body that extends from an upstream end to a downstream end. The tubular body includes an interior surface that surrounds a flow path for conveying loose fill insulation. The plurality of module sections includes a first fiber sizing module section, a first fiber conditioning module section, and an installation module section. The first fiber sizing module section includes an upstream connector disposed at the upstream end, a downstream connector disposed at the downstream end, and a plurality of cutting projections extending into the path that are configured to cut fibers of the loose fill insulation. The first fiber conditioning module section is configured to open the loose fill insulation and includes an upstream connector disposed at the upstream end and a downstream connector disposed at the downstream end. The installation module section includes an upstream connector disposed at the upstream end, a reducing portion that narrows the size of the tubular body, and a nozzle opening at the downstream end. Each of the upstream connectors is adapted to couple to any of the downstream connectors.

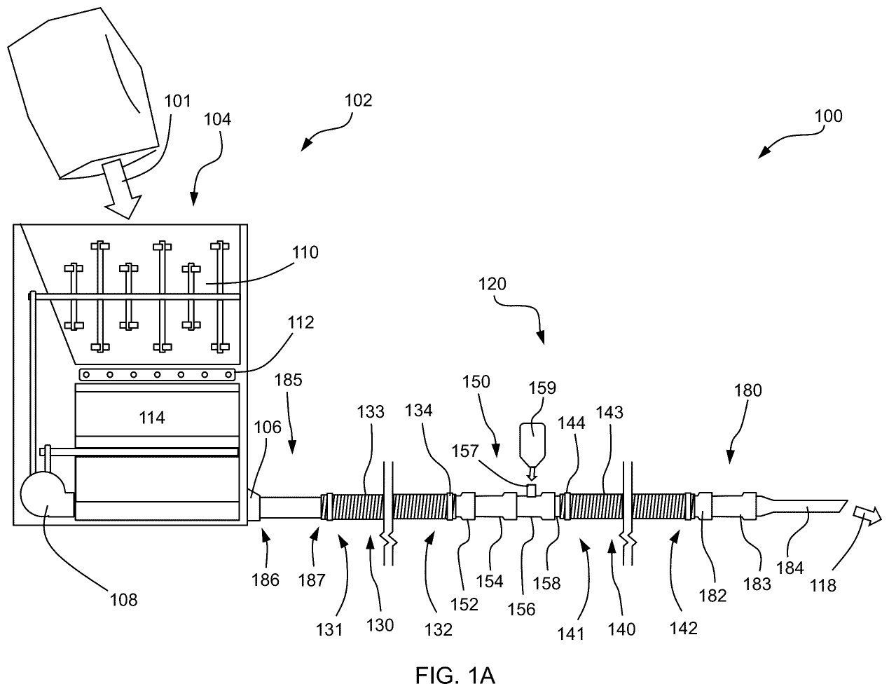

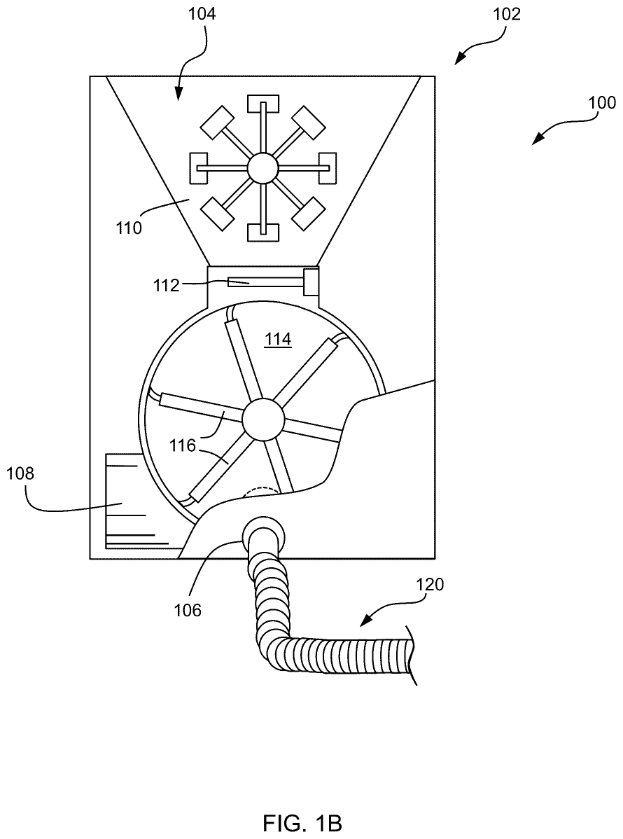

Connection modules formed from such a kit are schematically shown in FIG. 1A as part of a loose fill insulation hose of a loose fill insulation system. As shown in FIG. 1A, loose fill insulation system 100 includes a blowing machine coupled to a loose fill insulation hose 120. Loose fill insulation blowing machine 102 includes a hopper 104 configured to receive insulation. Blowing machine 102 partially conditions the insulation, which is then delivered to hose 120 through outlet 106 through the use of a blower 108. The blower 108 circulates air through blowing machine 102 to carry the loose fill insulation through hose 120 to an installation site at the distal end of the hose.

In some embodiments, the hopper includes a shredder box configured to break apart the loose fill insulation. For example, hopper 104 includes a shredder box 110 including a plurality of shredding members that rotate through the packed insulation to break the insulation apart and “open” the insulation.

Further, in some embodiments, the loose fill insulation blowing machine includes an air lock configured to transfer the loose fill insulation to the outlet. For example, as shown in FIG. 1B, the insulation in system 100 moves from the shredder box 110 through a stator bar 112 that includes tines for further opening the insulation and into an air lock 114. The air lock 114 includes a plurality of sealed vanes 116 that rotate around a drum and transport the insulation to an area where the air flow from blower 108 carries the insulation through outlet 106. The air lock 114 directs the air flow out through the outlet 106 rather than back into the shredder box 110.

Loose fill insulation hose 120 includes several tubular sections coupled together to form a conduit for conveying loose fill insulation along a path from a blowing machine to an installation site. As used herein, the term “coupled” is not limited to direct connections between elements. Rather, two tubular sections may be coupled to one another indirectly by other sections such that both tubular sections form part of the same path for loose fill insulation. In contrast, the term “attached”, as used herein, refers to a direct connection between two components, potentially with a coating, lining or seal therebetween.

As shown in FIG. 1A, loose fill insulation hose 120 includes a proximal hose section 130 and a distal hose section 140 that are connected together. The proximal end of the loose fill insulation hose 120 is attached to the blowing machine 102 and the distal end can be positioned at an installation site where loose fill installation is delivered. Proximal hose section 130 includes a flexible body 133 that extends from a proximal end 131 to a distal end 132. Similarly, distal hose section 140 also includes a flexible body 143 that extends from a proximal end 141 to a distal end 142.

Loose fill insulation hose 120 also includes two connection modules including central connection module 150 between proximal hose section 130 and distal hose section 140, as well as distal connection module 180 at the distal end 142 of distal hose section 140.

In the embodiment of loose fill insulation hose 120, as shown in FIG. 1A, the hose sections are attached to the connection modules using clamps. For example, proximal hose section 130 is coupled to central connection module 150 using a clamp 134 that surrounds proximal hose section 130 and fastens the proximal hose section 130 to the central connection module 150. Similarly, distal hose section 140 is coupled to the opposite end of central connection module 150 using another clamp 144. On the other hand, in some embodiments, the hose sections include end fittings that are configured to attach to the connection modules. Other methods of securing the hose sections to the connection modules are also possible.

The central connection module 150 and the distal connection module 180 of loose fill insulation hose 120 are each formed of several module sections formed from a kit in accordance with the disclosure. Specifically, central connection module 150 is formed by four module sections 152, 154, 156, 158 while distal connection module 180 is formed by three module sections 182, 183, 184. (Module section 158 is substantially obscured by module section 156 and distal hose section 140.) The individual module sections may have various different structural configurations and functions, as described in more detail below.

In certain embodiments of the kit as otherwise described herein, the plurality of module sections includes an additive module section including at least one delivery port on the interior surface for delivering an additive into the flow path. For example, loose fill insulation hose 120 in system 100 includes an additive module section 156 that has a delivery port 157 for providing an additive 159 into the hose interior. The additive module section 156 includes upstream and downstream connectors for attaching to other module sections for forming a connection module. As explained in more detail below, the additive may include any of various substances for providing certain characteristics to the loose fill insulation.

In certain embodiments of the kit as otherwise described herein, the plurality of module sections includes a second fiber sizing module section. For example, in some embodiments, the kit may include a plurality of fiber sizing module sections. As a result, a user may include a fiber sizing module section in more than one connection module within a loose fill insulation hose. Further, in some embodiments, the user can form a single connection module that includes several fiber sizing module sections. By including more fiber sizing module sections within the loose fill insulation hose, the average size of fibers of loose fill insulation that have passed through the hose may be further reduced. Accordingly, the user can adapt the loose fill insulation hose to yield a desired average fiber length based on the use of the insulation. Such adaptability may allow the same insulation to be used in scenarios that would ordinarily warrant different types of insulation.

In certain embodiments of the kit as otherwise described herein, the plurality of module sections includes a second fiber conditioning module section. For example, in some embodiments, the kit may include a plurality of fiber conditioning module sections. As a result, a user may include a fiber conditioning module section in more than one connection module within a loose fill insulation hose. Further, in some embodiments, the user can form a single connection module that includes several fiber conditioning module sections. By including more fiber conditioning module sections within the loose fill insulation hose, the density of the installed insulation may be adjusted.

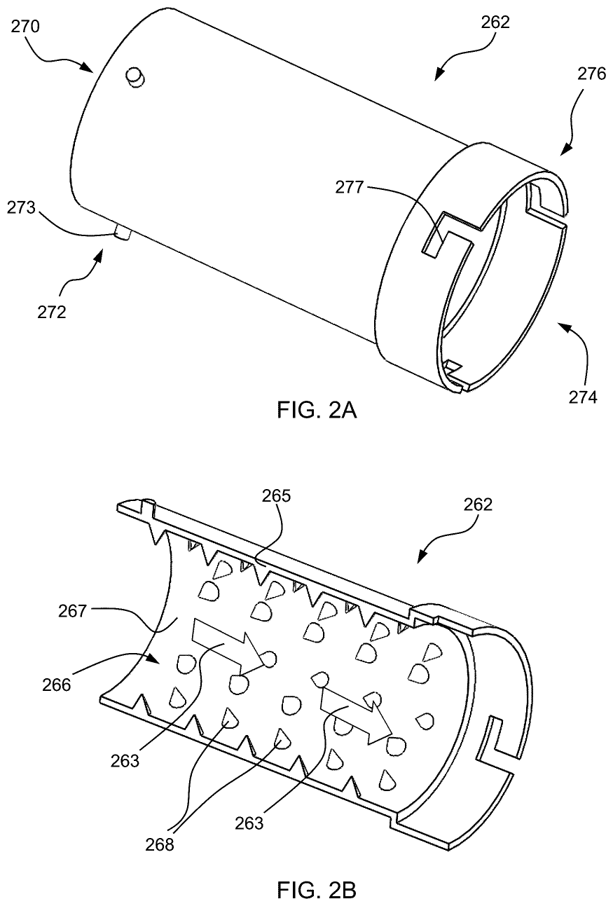

In certain embodiments of the kit as otherwise described herein, the cutting projections of the first fiber sizing module include spikes that extend into the flow path. For example, such a fiber sizing module section is shown in FIGS. 2A and 2B. Fiber sizing module section 262 includes a tubular body 265 that extends from an upstream end 270 to a downstream end 274. An upstream connector 272 is positioned at the upstream end 270 and is configured to attach to a corresponding downstream connector of another module section. Similarly, a downstream connector 276 is positioned at the downstream end 274 and is configured to attach to a corresponding upstream connector of another module section.

Tubular body 265 has an interior surface 266 that surrounds a path 263 for conveyed loose fill insulation. Interior surface 266 has a major surface portion 267 that defines the outer portion of the conduit through tubular body 265. A plurality of cutting projections 268 that have a spiked shape extend radially inward from major surface portion 267 into the path 263. The spiked cutting projections 268 are configured to cut the fibers of loose fill insulation through the fiber sizing module section 262.

In other embodiments, the cutting projections may have another configuration or shape. For example, in some embodiments, the cutting projections of the fiber sizing module include blades that extend into the flow path. Further, in some embodiments, the cutting projections include screens that extend across the flow path. Moreover, in some embodiments, the fiber sizing module section may include cutting projections that have several different configurations. For example, in some embodiments, the fiber sizing module section may include any combination of spiked projections, blades, screens and other cutting projections.

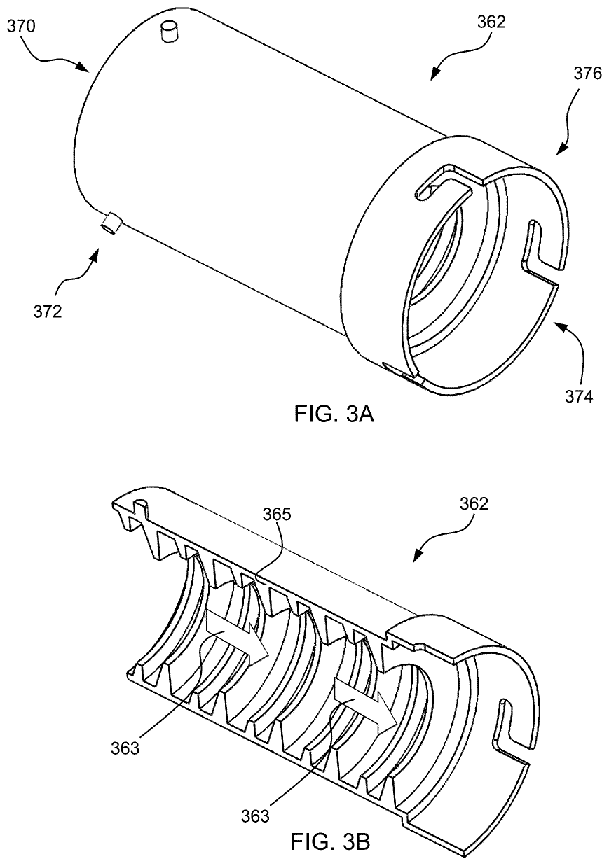

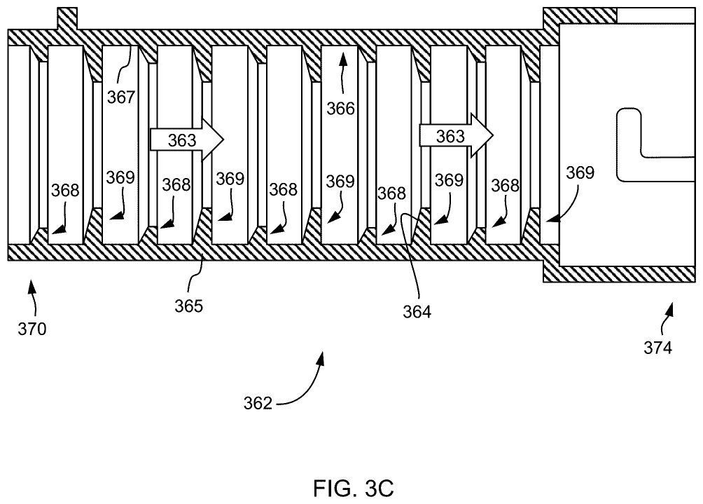

In certain embodiments of the kit as otherwise described herein, the first fiber conditioning module section includes a plurality of conditioning projections extending into the flow path. For example, such a fiber conditioning module section is shown in FIGS. 3A-3C. As shown in FIGS. 3A and 3B, fiber conditioning module section 362 includes a tubular body 365 that extends from an upstream end 370 to a downstream end 374. An upstream connector 372 is positioned at the upstream end 370 and is configured to attach to a corresponding downstream connector of another module section. Similarly, a downstream connector 376 is positioned at the downstream end 374 and is configured to attach to a corresponding upstream connector of another module section.

As shown in FIG. 3C, tubular body 365 has an interior surface 366 that surrounds a path 363 for conveyed loose fill insulation. Interior surface 366 has a major surface portion 367 that defines the outer portion of the conduit through tubular body 365. A plurality of projections 368, 369 extend radially inward from major surface portion 367 into the path 363. The projections 368, 369 are configured to open the loose fill insulation as it travels through fiber conditioning module section 362. As air carries the loose fill insulation through fiber conditioning module section 362, fibers or particles of the loose fill insulation may catch on the projections 368, 369 and be pulled open or apart.

In certain embodiments of the kit as otherwise described herein, the plurality of conditioning projections comprises a series of annular projections along a length of the tubular body. For example, as shown in FIG. 3C, each of the projections 368, 369 of fiber conditioning module section 362 is formed as an annular ring that encircles path 363 and extends radially inward from interior surface 366 around the circumference of tubular body 365. The projections 368, 369 are spaced at regular intervals along the length of fiber conditioning module section 362. In other embodiments, the spacing along the length of the fiber conditioning module section is irregular. Further, in some embodiments, the projections of the fiber conditioning module section are not annular and have other shapes and forms. For example, the projections may have various different shapes, such as square, triangular, round, or other shapes, including randomly configured shapes.

In certain embodiments of the kit as otherwise described herein, the series of annular projections includes smaller projections that extend into the path by a first radial depth and larger projections that extend into the path by a second radial depth that is greater than the first radial depth. For example, fiber conditioning module section 362 includes a group of larger projections 369 that extend into path 363 by about 25% of the diameter of major surface portion 367, and a group of smaller projections 368 that extend radially inward about half the distance of larger projections 369. The use of both larger and smaller projections may help increase turbulence of the air flowing through fiber conditioning module section 362, which can assist in conditioning loose fill insulation travelling through the hose.

In certain embodiments of the kit as otherwise described herein, the smaller projections and larger projections alternate along the length of the fiber conditioning module section. For example, the smaller projections 368 of fiber conditioning module section 362 are interspersed between the larger projections 369. This repeated change in diameter may also increase turbulence within fiber conditioning module section 362. In other embodiments, the smaller and larger projections are arranged in a different pattern. For example, in some embodiments, the fiber conditioning module section includes a greater number of smaller projections upstream and greater number of larger projections downstream. On the other hand, in other embodiments the fiber conditioning module section includes a greater number of smaller projections downstream.

In certain embodiments of the kit as otherwise described herein, at least some of the annular projections are tapered so as to have a reduced thickness at a radially inner edge. For example, in some embodiments, the upstream surface of the projections has a conical shape such that the projection narrows toward the center of the connection module. For example, each of the projections 368, 369 of the tapered annular projections of fiber conditioning module section 362 include a conical upstream surface as demonstrated by surface 364 in FIG. 3C. The conical shape of the upstream surface of projections 368 and 369 can help direct the flow through fiber conditioning module section 362 by angling toward the open center of the tubular body 365. While the projections 368, 369 of the fiber conditioning module section 362 have a flat downstream surface, in other embodiments, the projections include conical surfaces on both sides, such that the projections may be symmetric.

In certain embodiments of the kit as otherwise described herein, each of the larger projections has the same geometry. Likewise, in some embodiments each of the smaller projections has the same geometry. For example, in fiber conditioning module section 362, each of the larger projections 369 have the same geometry and each of the smaller projections 368 also have the same geometry. In other embodiments, the projections have different shapes and sizes. For example, in some embodiments, the fiber conditioning module section includes smaller projections with a range of radial depths that vary but are all below a threshold depth, and larger projections within a range of radial depths that are all above the threshold depth. Such projections may have similar shapes or different shapes.

In some embodiments, the annular projections are perpendicular to the length of the fiber conditioning module section. For example, each of the projections 368, 369 of fiber conditioning module section 362 is aligned around an axis of the module section 362 so that the annular projections are perpendicular to the length of the module section 362. In other embodiments, the annular projections are tilted with respect to the length of the connection module.

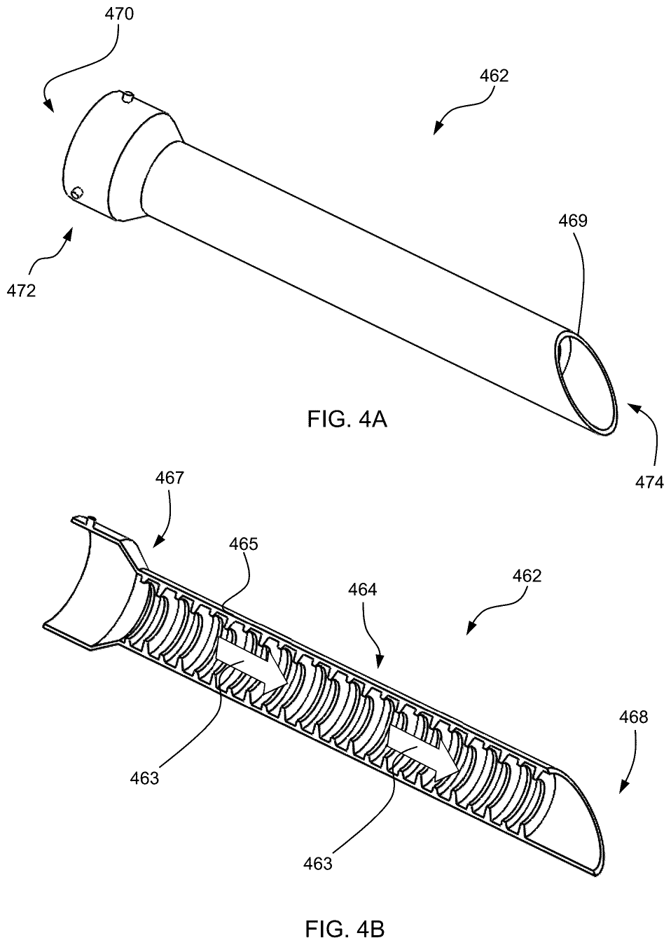

FIGS. 4A and 4B illustrate an installation module section according to an embodiment of the disclosure. Installation module section 462 includes a tubular body 465 that extends from an upstream end 470 to a downstream end 474. Similar to fiber sizing module section 262 and fiber conditioning module section 362, installation module section 462 includes an upstream connector 472 positioned at the upstream end 470 that is configured to attach to a corresponding downstream connector of another module section. However, at the downstream end, installation module section 462 includes a nozzle opening 468 and does not include a downstream connector.

Tubular body 465 has an interior surface that surrounds a path 463 for conveyed loose fill insulation. The diameter of tubular body 465 at the upstream end is similar to other module sections of the kit. However, installation module section 462 also includes a reducing portion 467 that narrows the size of the tubular body 465. The reducing portion 467 is between the upstream end and nozzle opening 468 at the downstream end. Accordingly, the diameter of the tubular body 465 is narrower at the nozzle opening 468.

In certain embodiments of the kit as otherwise described herein, the nozzle opening of the installation module section is angled. For example, nozzle opening 468 of installation module section 462 has an outer edge 469 that lies in a plane disposed at an acute angle (e.g., between 30 and 60 degrees from an axis of the tubular body 465. The angled nozzle opening 468 gives the insulation module section 462 a pointed end, which may help make inserting the installation module section 462 into cavities easier. For example, a user may employ the angled nozzle opening 468 to insert the installation module section through a fabric covering a wall cavity.

In certain embodiments of the kit as otherwise described herein, the installation module section includes an elongate duct downstream of the reducing portion. For example, installation module section 462 includes an elongate duct 464 between reducing portion 467 and nozzle opening 468. The elongate duct 464 may allow the nozzle opening 468 of the installation module section 462 to be positioned more easily for installing insulation. For example, where the installation module section 462 is inserted into a wall cavity, the nozzle opening 468 can be moved to different areas within the cavity by angling the elongate duct 464 in different directions. In some embodiments, the elongate duct may have a length of at least 6 inches, e.g., a length of at least 12 inches.

In some embodiments, as shown in FIG. 4B, the interior surface of the installation module section may include projections, for example for fiber sizing or conditioning. In other embodiments, the interior surface of the installation module section may be smooth.

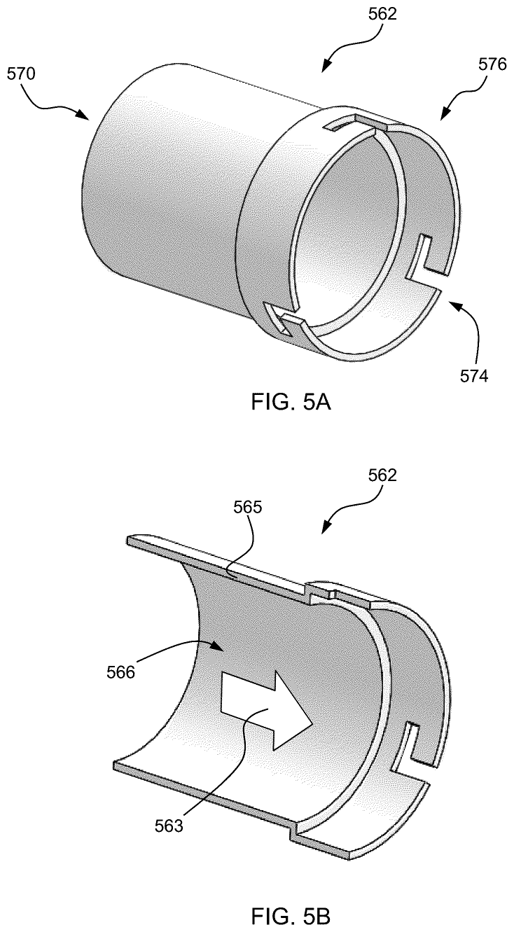

In certain embodiments of the kit as otherwise described herein, the plurality of module sections includes an upstream hose adapter module section including a smooth exterior at the upstream end for receiving a section of hose and a downstream connector at the downstream end. Such a module section is shown in FIGS. 5A and 5B. Upstream hose adapter module section 562 includes a tubular body 565 extending from an upstream end 570 to a downstream end 574. Tubular body 565 includes an interior surface 566 that surrounds a path 563 for conveyed loose fill insulation. Upstream hose adapter module section 562 also includes a downstream connector 576 at the downstream end 574 but includes a smooth exterior at the upstream end 570. The smooth exterior allows a hose section to be secured to the upstream hose adapter module section 562, for example using a hose clamp, while the downstream end 574 of the upstream hose adapter module section can be secured to other module sections using the downstream connector 576.

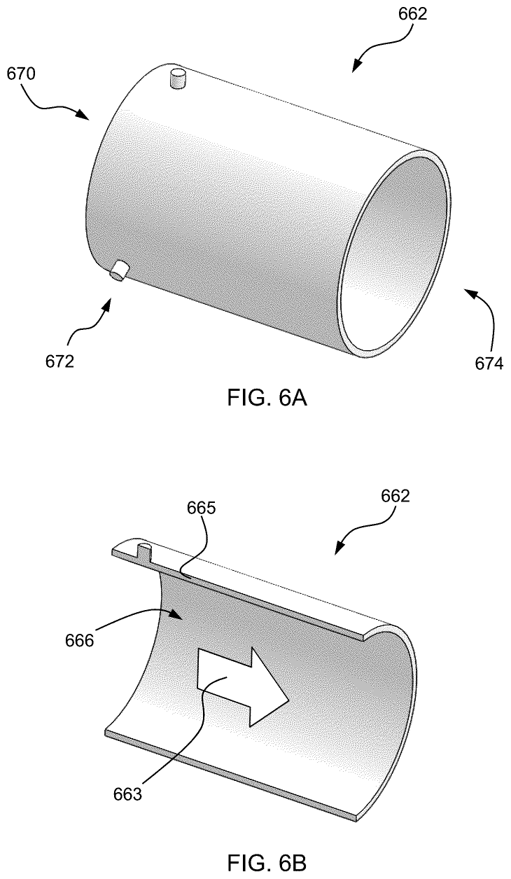

In certain embodiments of the kit as otherwise described herein, the plurality of module sections includes a downstream hose adapter module section including an upstream connector at the upstream end and a smooth exterior at the downstream end for receiving a section of hose. Such a module section is shown in FIGS. 6A and 6B. Downstream hose adapter module section 662 includes a tubular body 665 extending from an upstream end 670 to a downstream end 674. Tubular body 665 includes an interior surface 666 that surrounds a path 663 for conveyed loose fill insulation. Downstream hose adapter module section 662 also includes a upstream connector 672 at the upstream end 670 but includes a smooth exterior at the downstream end 674. Again, the smooth exterior allows a hose section to be conveniently secured to the downstream hose adapter module section 662 while the upstream end 670 of the downstream hose adapter module section 662 can be secured to other module sections using the upstream connector 672.

While the upstream and downstream hose adapter module sections allow for convenient attachment of a connector module to a hose section using a dedicated module section, in some embodiments, the kit may exclude either or both hose adapter module sections and have other module sections that are configured for attachment to a hose section

In certain embodiments of the kit as otherwise described herein, each of the upstream connectors of the kit have the same configuration. Further, in some embodiments, each of the downstream connectors of the kit have the same configuration. By providing each of the upstream connectors with the same configuration and each of the downstream connectors with the same configuration, the module sections can be coupled to one another in a variety of different arrangements, with the number and order of module sections selected by the user for a particular application.

In certain embodiments of the kit as otherwise described herein, the upstream connectors and downstream connectors are twist lock connectors. For example, as shown in FIG. 2A, fiber sizing module section 262 has an upstream connector 272 that includes a protrusion 273 on the exterior side of the tubular body 265. Fiber sizing module section 262 also has a downstream connector 276 that includes an enlarged diameter configured to receive the upstream end of another module section and a hooked slot 277 adapted to receive the protrusion of the other module section. Accordingly, to connect two of such module sections, the protrusion is inserted into the hooked slot and the two module sections are twisted with respect to one another so that the protrusion moves toward the closed end of the hooked slot.

In other embodiments, the upstream and downstream connectors may have another configuration. For example, in some embodiments, the upstream connectors and downstream connectors are snap-fit connectors. In other embodiments, the upstream connectors and downstream connectors are friction-fit connectors.

In certain embodiments of the kit as otherwise described herein, the diameter of the interior surface at the upstream end of the module sections is at least 1.5 inches, e.g., at least 2 inches, e.g., at least 2.5 inches. In some embodiments, the diameter of the interior surface at the upstream end of the module sections is no more than 8 inches, e.g., no more than 6 inches, e.g., no more than 4 inches. For example, in some embodiments, the diameter of the interior surface at the upstream end of the module sections is in a range from 1.5 inches to 8 inches, e.g., from 2 inches to 6 inches; or from 1.5 inches to 4 inches, e.g., from 2.5 inches to 3.5 inches. Further, in some embodiments each of the module sections has the same inner diameter at the upstream end. In other embodiments, some of the connection modules have different inner diameters at the upstream end.

In another aspect, the disclosure provides a method of delivering loose fill insulation. The method includes assembling a first group of module sections of the kit of the disclosure to form a first connection module, and then assembling a loose fill insulation hose having a first configuration and including a hose section and the first connection module. The method also includes connecting the loose fill insulation hose having the first configuration to a blowing machine. A first quantity of loose fill insulation is loaded into the blowing machine and conveyed from the blowing machine, through the loose fill insulation hose having the first configuration, and to a first installation site in a building structure.

Such a method is depicted in FIG. 1A. A loose fill insulation hose 120 is assembled using two hose section 130, 140, a central connection module 150 and a distal connection module 180. Both the central connection module 150 and the distal connection module 180 are formed from several module sections of a kit of module sections. In particular, central connection module 150 is formed from module sections 152, 154, 156 and 158, while distal connection module 180 is formed from module sections 182, 183, 184. The loose fill insulation hose 120 is also attached to the blowing machine 102.

Packed insulation 101 is then introduced into blowing machine 102 via the hopper 104. The packed insulation 101 is broken up and opened by the shredder box 110 and stator bar 112 as it moves into air lock 114. The air lock 114 then moves the insulation to a position where air from blower 108 can carry the insulation through hose 120 to an installation site at the distal end of hose 120, where the loose fill insulation 118 is delivered to the installation site.

In certain embodiments of the method as otherwise described herein, the method further includes assembling a second group of module sections of the kit to form a second connection module and assembling a loose fill insulation hose having a second configuration that includes a hose section and the second connection module. The method also includes connecting the loose fill insulation hose having the second configuration to the blowing machine. A second quantity of loose fill insulation is loaded into the blowing machine and conveyed from the blowing machine, through the loose fill insulation hose having the second configuration, to a second installation site in the building structure.

For example, in some embodiments, after installing loose fill insulation at the first installation site, the system is reconfigured for installation of loose fill insulation at a second site that warrants different insulation properties. Accordingly, the loose fill insulation hose is reassembled to have a different configuration. In particular, at least one of the connection modules is rearranged to use a different group of module sections. The different module sections will condition the loose fill insulation different. Accordingly, the module sections may be selected and ordered to condition the loose fill insulation based on the needs at the second installation site.

In certain embodiments of the method as otherwise described herein, the first quantity of loose fill insulation and the second quantity of loose fill insulation have the same properties. For example, in some embodiments, despite the desire to have insulation with different performance properties at the first installation site and the second installation site within the building structure, the same loose fill insulation product is provided in the hopper of the blowing machine. However, in view of the different connection module configurations that are used when installing the insulation at the first installation site and when installing the insulation at the second installation site, the installed insulation has different performance characteristics.

For example, in some embodiments, the first group of module sections includes more fiber sizing module sections than the second group of module sections. As a result, when the loose fill insulation is installed at the first installation site, using the hose that includes the first group of module sections with more fiber sizing module sections, the fibers of the insulation are cut more as they are conveyed through the hose. In contrast, as the fibers are conveyed to the second installation site through the hose configuration with fewer fiber sizing module sections, the fibers are cut less. Accordingly, the insulation installed at the first installation site has a shorter average fiber length than the insulation installed at the second installation site.

Similarly, in some embodiments, the second group of module sections includes more fiber conditioning module sections than the first group of module sections. In such an embodiment, as the loose fill insulation is installed at the first installation site, using the hose that includes the first group of module sections with fewer fiber conditioning module sections, the fibers of the insulation are opened less and the installed insulation is denser. On the other hand, when the fibers are conveyed to the second installation site through the hose configuration that includes more fiber conditioning module sections, the fibers are opened more, resulting in a lower density of the installed insulation.

In certain embodiments of the method as otherwise described herein, the first group of module sections includes an installation module section and the second group of module sections excludes the installation module section. For example, in some embodiments, the first installation site is a wall cavity and the second installation site is an attic. Accordingly, during the installation at the first installation site, the user includes an installation module section in order to direct the insulation into the wall cavity. On the other hand, when installing the insulation in the attic, the user elects to use a distal connection module without the installation module section, thereby allowing the insulation to be blow over a larger area of the attic.

In certain embodiments of the method as otherwise described herein, the first group of module sections includes an additive module section, and the method includes supplying additive into the loose fill insulation hose as the loose fill insulation is conveyed through the loose fill insulation hose. For example, central connection module 150 in loose fill insulation hose 120 of system 100 includes an additive module section 156 including a delivery port 157 for an additive 159. During installation of loose fill insulation, the additive module section 156 may be used to include an additive in the loose fill insulation. The additive may include any of various substances for providing certain characteristics to the loose fill insulation. For example, the additive may include an antistatic agent, dust suppressant, mold suppressant, moisture control agent, fire retardant, or pest control agent.

In certain embodiments as otherwise described herein, the delivery port is connected to a pump configured to meter additive into the flow path. Further, in some embodiments, the delivery port is connected to a valve configured to meter the additive into the flow path. Moreover, while in some embodiments, the system may include both a pump and a valve to deliver additive, in other embodiments the system may include a valve without a pump. For example, in some embodiments a pressure differential between a container holding the additive and the path of the loose fill insulation causes the additive to be metered into the deliver port by the valve alone. For example, the valve may be configured to slowly meter the additive into the delivery port based on the pressure differential, or the valve may be actively controlled to meter the additive. In other embodiments, the pump may be able to control the delivery of the additive from a container without the use of a separate valve. Further still, in some embodiments, the system may be configured to receive a container that meters the additive in one of the aforementioned or another manner.

In certain embodiments of the method as otherwise described herein, the additive is mixed with additional additives. For example, in some embodiments, the additive is included in a solution that includes one or more additional additives. The additional additives may have compositions that complement the function of the additive or that perform other functions. For example, in some embodiments, a solution may be introduced through the delivery port that includes an antistatic agent as the additive and also a dust suppressant. Further, in some embodiments, the additive may have more than one function. For example, in some embodiments, the first suppressant may be a dust suppressant that also functions as a fire retardant.

In some embodiments, the additive is contained in a solution that includes water. For example, in some embodiments the additive is contained in a solution that is up to 50% water. In other embodiments the additive is contained in a solution that is more than 50% water, e.g., more than 60% water, e.g., more than 70% water, e.g., more than 80% water, e.g., more than 90% water, e.g., more than 95% water. Further, in some embodiments, the additive is contained in a solution comprising a liquid other than water. Further still, in some embodiments the additive is a dry additive. For example, in some embodiments, the additive is a powder or other solid.

In certain embodiments of the method, the loose fill insulation hose further comprises a proximal connection module including a first side configured to attach to an outlet of a loose fill insulation blowing machine and a second side attached to the proximal end of the first hose section. For example, loose fill insulation hose 120, shown in FIGS. 1A and 1B, includes a proximal connection module 185 that has a first side 186 and a second side 187. The second side 187 of the proximal connection module 185 is attached to the proximal end 131 of proximal hose section 130 while the first side 186 of proximal connection module 185 is attached to an outlet 106 of loose fill insulation blowing machine 102. Accordingly, proximal connection module 185 is at the proximal end of loose fill insulation hose 120 and receives the loose fill insulation as it leaves blowing machine 102. In some embodiments, the proximal connection module may be formed by module sections of the kit of the disclosure.

Alternatively, in other embodiments, the loose fill insulation hose includes a proximal connection module and a coupler configured to attach to an outlet of the loose fill insulation blowing machine. In such an embodiment, a first side of the proximal connection module is attached to the coupler and a second side of the proximal connection module is attached to the proximal end of a hose section. In some embodiments, the coupler is used to enable the connection between the loose fill insulation hose and the outlet of the blowing machine. For example, in some embodiments, the coupler has two female couplings to receive male couplings on the blowing machine outlet and proximal connection module. In other embodiments, the coupler has two male couplings. In still yet other embodiments the coupler may contain one male and one female coupling on opposite ends. Further, in some embodiments, the coupling changes the diameter of the opening so that a hose and blowing machine outlet of different diameters can be connected.

In other embodiments the loose fill insulation hose does not include a proximal connection module. For example, in some embodiments, one of the hose sections is either directly attached to the blowing machine outlet or is attached to the blowing machine outlet using a coupler.

In certain embodiments of the method, the hose section is corrugated. For example, proximal hose section 130 of loose fill insulation hose 120, as shown in FIGS. 1A and 1B, has a corrugated tubular body 133. Corrugated hose can have increased flexibility and strength compared to similar hose with a smooth outer surface. The other hose sections of loose fill insulation hose 120 are similarly corrugated, as shown in FIGS. 1A and 1B. In other embodiments, the hose section may have a different profile, such as smooth.

In certain embodiments of the method described herein, the hose section has a length of at least 10 feet, e.g., at least 15 feet, e.g., at least 20 feet. In some embodiments, the first hose section has a length of no more than 100 feet, e.g., no more than 80 feet, e.g., no more than 60 feet, e.g., about 50 feet. For example, in some embodiments, the hose section has a length in a range from 10 feet to 100 feet, e.g., from 12 feet to 80 feet, e.g., from 15 feet to 60 feet, e.g., from 20 feet to 50 feet. In some embodiments each of the hose sections has the same length. In other embodiments the hose sections of the loose fill insulation hose have different lengths.

In certain embodiments of the method described herein, an inner diameter of the hose section is at least 1.5 inches, e.g., at least 2 inches, e.g., at least 2.5 inches. In certain embodiments of the loose fill insulation hose as otherwise described herein, an inner diameter of the first hose section is no more than 8 inches, e.g., no more than 6 inches, e.g., no more than 4 inches. For example, in some embodiments, the inner diameter of the hose section is in a range from 1.5 inches to 8 inches, e.g. from 2 inches to 6 inches, e.g., from 2.5 inches to 4 inches. Further, in some embodiments each of the hose sections has the same inner diameter.

In other embodiments, some of the hose sections within the hose have different inner diameters. For example, in some embodiments, the hose sections reduce in diameter along the length of the hose. In other embodiments, the hose sections increase in diameter along the length of the hose. Still, in other embodiments, the hose sections may both increase and decrease in diameter along the length of the hose. Such changes in diameter along the length of the hose may change the pressure within the hose, thereby allowing for more conditioning of the loose fill insulation, may increase or decrease the exit pressure from the hose, or provide other beneficial fiber handling results.

In certain embodiments of the method as otherwise described herein, the loose fill insulation includes a fibrous material. For example, in some embodiments, the loose fill insulation is a fiberglass insulation, a cellulose insulation, a stonewool insulation, a plastic fiber insulation, a natural wool insulation, a natural cotton insulation, or another insulation including fibers. In other embodiments, the loose fill insulation includes small insulating components, such as a foam bead insulation or a plastic particle insulation.

Various aspects and embodiments of the disclosure are illustrated by the following list of non-limiting enumerated embodiments, which can be combined in any number and in any combination not technically or logically inconsistent.
Embodiment 1. A kit for forming one or more connection modules for use with a loose fill insulation hose, the kit comprising:
   a plurality of module sections configured to be attached in a variety of configurations that provide different performance characteristics, each of the module sections including a tubular body extending from an upstream end to a downstream end and including an interior surface that surrounds a flow path for conveying loose fill insulation, the plurality of module sections including:
      a first fiber sizing module section including an upstream connector disposed at the upstream end, a downstream connector disposed at the downstream end, and a plurality of cutting projections extending into the path that are configured to cut fibers of the loose fill insulation,
      a first fiber conditioning module section configured to open the loose fill insulation and including an upstream connector disposed at the upstream end and a downstream connector disposed at the downstream end, and
      an installation module section including an upstream connector disposed at the upstream end, a reducing portion that narrows the size of the tubular body, and a nozzle opening at the downstream end,
   wherein each of the upstream connectors is adapted to couple to any of the downstream connectors.
Embodiment 2. The connection module kit according to embodiment 1, wherein the plurality of module sections includes an additive module section including at least one delivery port on the interior surface for delivering an additive into the flow path.
Embodiment 3. The connection module kit according to embodiment 2, wherein the delivery port is connected to a pump configured to meter additive into the flow path.
Embodiment 4. The connection module kit according to embodiment 2 or embodiment 3, wherein the delivery port is connected to a valve configured to meter the additive into the flow path.
Embodiment 5. The connection module kit according to any of embodiments 1 to 4, wherein the plurality of module sections includes an upstream hose adapter module section including a smooth exterior at the upstream end for receiving a section of hose and a downstream connector at the downstream end.
Embodiment 6. The connection module kit according to any of embodiments 1 to 5, wherein the plurality of module sections includes a downstream hose adapter module section including an upstream connector at the upstream end and a smooth exterior at the downstream end for receiving a section of hose.
Embodiment 7. The connection module kit according to any of embodiments 1 to 6, wherein the plurality of module sections includes a second fiber sizing module section.
Embodiment 8. The connection module kit according to any of embodiments 1 to 7, wherein the plurality of module sections includes a second conditioning module section.
Embodiment 9. The connection module kit according to any of embodiments 1 to 8, wherein the cutting projections of the first fiber sizing module section include spikes that extend into the flow path.
Embodiment 10. The connection module kit according to any of embodiments 1 to 9, wherein the cutting projections of the first fiber sizing module section include blades that extend into the flow path.
Embodiment 11. The connection module kit according to any of embodiments 1 to 10, wherein the cutting projections of the first fiber sizing module section include screens that extend across the flow path.
Embodiment 12. The connection module kit according to any of embodiments 1 to 11, wherein the first fiber conditioning module section includes a plurality of conditioning projections extending into the flow path.
Embodiment 13. The connection module kit according to embodiment 12, wherein the plurality of conditioning projections comprises a series of annular projections along a length of the tubular body including smaller projections that extend into the flow path by a first radial depth and larger projections that extend into the flow path by a second radial depth that is greater than the first radial depth.
Embodiment 14. The connection module kit according to embodiment 13, wherein the smaller projections and larger projections alternate along the length of the first connector section.
Embodiment 15. The connection module kit according to embodiment 13 or embodiment 14, wherein at least some of the annular projections are tapered so as to have a reduced thickness at a radially inner edge.
Embodiment 16. The connection module kit according to embodiment 15, wherein the tapered annular projections include a conical upstream surface.
Embodiment 17. The connection module kit according to any of embodiments 13 to 16, wherein each of the larger projections has the same geometry.
Embodiment 18. The connection module kit according to any of embodiments 13 to 17, wherein each of the smaller projections has the same geometry.
Embodiment 19. The connection module kit according to any of embodiments 1 to 18, wherein each of the upstream connectors of the kit have the same configuration.
Embodiment 20. The connection module kit according to any of embodiments 1 to 19, wherein each of the downstream connectors of the kit have the same configuration.
Embodiment 21. The connection module kit according to any of embodiments 1 to 20, wherein the upstream connectors and downstream connectors are twist lock connectors.
Embodiment 22. The connection module kit according to any of embodiments 1 to 20, wherein the upstream connectors and downstream connectors are snap-fit connectors.
Embodiment 23. The connection module kit according to any of embodiments 1 to 20, wherein the upstream connectors and downstream connectors are friction-fit connectors.
Embodiment 24. The connection module kit according to any of embodiments 1 to 23, wherein the nozzle opening of the installation module section is angled.
Embodiment 25. The connection module kit according to any of embodiments 1 to 24, wherein the installation module section includes an elongate duct downstream of the reducing portion.
Embodiment 26. A method of delivering loose fill insulation, the method comprising:
   assembling a first group of module sections of the kit of any of embodiments 1 to 25 to form a first connection module;
   assembling a loose fill insulation hose having a first configuration and including a hose section and the first connection module;
   connecting the loose fill insulation hose having the first configuration to a blowing machine;
   loading a first quantity of loose fill insulation into the blowing machine; and
   conveying the first quantity of loose fill insulation from the blowing machine, through the loose fill insulation hose having the first configuration, to a first installation site in a building structure.
Embodiment 27. The method according to embodiment 26 further comprising:
   assembling a second group of module sections of the kit to form a second connection module;
   assembling a loose fill insulation hose having a second configuration and including a hose section and the second connection module;
   connecting the loose fill insulation hose having the second configuration to the blowing machine;
   loading a second quantity of loose fill insulation into the blowing machine; and
   conveying the second quantity of loose fill insulation from the blowing machine, through the loose fill insulation hose having the second configuration, to a second installation site in the building structure.
Embodiment 28. The method according to embodiment 27, wherein the first quantity of loose fill insulation and the second quantity of loose fill insulation have the same properties.
Embodiment 29. The method according to embodiment 27 or embodiment 28, wherein the first group of module sections includes an installation module section and the second group of module sections excludes the installation module section.
Embodiment 30. The method according to any of embodiments 27 to 29, wherein the first installation site is a wall cavity and the second installation site is an attic.
Embodiment 31. The method according to any of embodiments 27 to 30, wherein the first group of module sections includes more fiber sizing module sections than the second group of module sections, and wherein the insulation installed at the first installation site has a shorter average fiber length than the insulation installed at the second installation site.
Embodiment 32. The method according to any of embodiments 27 to 31, wherein the second group of module sections includes more fiber conditioning module sections than the first group of module sections, and wherein the insulation installed at the first installation site is denser than the insulation installed at the second installation site.
Embodiment 33. The method according to any of embodiments 26 to 32, wherein the first group of module sections includes an additive module section, and wherein the method includes supplying additive into the loose fill insulation hose as the loose fill insulation is conveyed through the loose fill insulation hose.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

What is claimed is:

1. A kit for forming one or more connection modules for use with a loose fill insulation hose, the kit comprising:
a plurality of module sections configured to be attached in a variety of configurations that provide different performance characteristics, each of the module sections including a tubular body extending from an upstream end to a downstream end and including an interior surface that surrounds a flow path for conveying loose fill insulation, the plurality of module sections including:
a first fiber sizing module section including an upstream connector disposed at the upstream end, a downstream connector disposed at the downstream end, and a plurality of cutting projections extending into the path that are configured to cut fibers of the loose fill insulation,
a first fiber conditioning module section configured to open the loose fill insulation and including an upstream connector disposed at the upstream end and a downstream connector disposed at the downstream end, and
an installation module section including an upstream connector disposed at the upstream end, a reducing portion that narrows the size of the tubular body, and a nozzle opening at the downstream end,
wherein each of the upstream connectors is adapted to couple to any of the downstream connectors.

2. The connection module kit according to claim 1, wherein the plurality of module sections includes an additive module section including at least one delivery port on the interior surface for delivering an additive into the flow path.

3. The connection module kit according to claim 2, wherein the delivery port is connected to a pump or a valve configured to meter additive into the flow path.

4. The connection module kit according to claim 1, wherein the plurality of module sections includes an upstream hose adapter module section including a smooth exterior at the upstream end for receiving a section of hose and a downstream connector at the downstream end.

5. The connection module kit according to claim 1, wherein the plurality of module sections includes a downstream hose adapter module section including an upstream connector at the upstream end and a smooth exterior at the downstream end for receiving a section of hose.

6. The connection module kit according to claim 1, wherein the plurality of module sections includes a second fiber sizing module section or a second conditioning module section.

7. The connection module kit according to claim 1, wherein the cutting projections of the first fiber sizing module section include spikes that extend into the flow path.

8. The connection module kit according to claim 1, wherein the cutting projections of the first fiber sizing module section include blades that extend into the flow path.

9. The connection module kit according to claim 1, wherein the cutting projections of the first fiber sizing module section include screens that extend across the flow path.

10. The connection module kit according to claim 1, wherein the first fiber conditioning module section includes a plurality of conditioning projections extending into the flow path.

11. The connection module kit according to claim 10, wherein the plurality of conditioning projections comprises a series of annular projections along a length of the tubular body including smaller projections that extend into the flow path by a first radial depth and larger projections that extend into the flow path by a second radial depth that is greater than the first radial depth.

12. The connection module kit according to claim 11, wherein the smaller projections and larger projections alternate along the length of the first connector section.

13. The connection module kit according to claim 1, wherein the installation module section includes an elongate duct downstream of the reducing portion.

14. A method of delivering loose fill insulation, the method comprising:
assembling a first group of module sections of the kit of claim 1 to form a first connection module;
assembling a loose fill insulation hose having a first configuration and including a hose section and the first connection module;
connecting the loose fill insulation hose having the first configuration to a blowing machine;
loading a first quantity of loose fill insulation into the blowing machine; and
conveying the first quantity of loose fill insulation from the blowing machine, through the loose fill insulation hose having the first configuration, to a first installation site in a building structure.

15. The method according to claim 14 further comprising:
assembling a second group of module sections of the kit to form a second connection module;
assembling a loose fill insulation hose having a second configuration and including a hose section and the second connection module;
connecting the loose fill insulation hose having the second configuration to the blowing machine;
loading a second quantity of loose fill insulation into the blowing machine; and
conveying the second quantity of loose fill insulation from the blowing machine, through the loose fill insulation hose having the second configuration, to a second installation site in the building structure.

16. The method according to claim 15, wherein the first quantity of loose fill insulation and the second quantity of loose fill insulation have the same properties.

17. The method according to claim 15, wherein the first group of module sections includes an installation module section and the second group of module sections excludes the installation module section.

18. The method according to claim 15, wherein the first group of module sections includes more fiber sizing module sections than the second group of module sections, and wherein the insulation installed at the first installation site has a shorter average fiber length than the insulation installed at the second installation site.

19. The method according to claim 15, wherein the second group of module sections includes more fiber conditioning module sections than the first group of module sections, and wherein the insulation installed at the first installation site is denser than the insulation installed at the second installation site.

20. The method according to claim 14, wherein the first group of module sections includes an additive module section, and wherein the method includes supplying additive into the loose fill insulation hose as the loose fill insulation is conveyed through the loose fill insulation hose.
